(19) United States
(12) Patent Application Publication
(10) Pub. No.: US 2012/0328145 A1
(43) Pub. Date: Dec. 27, 2012

(54) WIRED EARPHONE WITH COILED ADHESIVE TAPE

(75) Inventor: HWANG-MIAW CHEN, Tu-Cheng (TW)

(73) Assignee: HON HAI PRECISION INDUSTRY CO., LTD., Tu-Cheng (TW)

(21) Appl. No.: 13/600,243

(22) Filed: Aug. 31, 2012

Related U.S. Application Data
(63) Continuation-in-part of application No. 13/091,142, filed on Apr. 21, 2011.

(30) Foreign Application Priority Data
Dec. 20, 2010 (CN) 201010596746.5

(51) Int. Cl. H04R 1/10

(52) U.S. Cl. 381/384

(57) ABSTRACT

An exemplary earphone includes a shell, a speaker received in the shell, and a wire electrically connecting with the speaker. The shell defines a sound cavity and a wire passage therein. The sound cavity and the wire passage communicate with each other. The speaker is received in the sound cavity. The wire is inserted into the sound cavity through the wire passage. An adhesive tape is wound around part of the wire. The adhesive tape abuts against an inner wall of the wire passage thereby fixing the wire in the wire passage.

### CROSS-REFERENCE TO RELATED APPLICATION

The present application is a continuation-in-part (CIP) application of patent application Ser. No. 13/091,142, entitled “WIRED EARPHONE,” and filed on Apr. 21, 2011. The disclosure of the parent application is incorporated herein by reference in its entirety.

### BACKGROUND

1. Technical Field

The present disclosure relates to wired earphones, and particularly to a wired earphone having adhesive tape coiled around part of the wire thereof.

2. Description of Related Art

A typical earphone includes a shell, a speaker mounted in the shell, and a wire electrically connected with the speaker. The shell defines a sound cavity therein and a through hole communicating with the sound cavity. The speaker is located in the sound cavity. The wire is inserted into the sound cavity through the through hole. A diameter of the through hole is usually slightly larger than that of the wire, for facilitating the wire to extend through the through hole. The wire is thus loosely received in the through hole of the shell. When the earphone is in use and the exposed portion of the wire is accidentally brushed or moved by the user, the wire is liable to move in the through hole and impact an inner wall of the shell around the through hole. This may generate unwanted noise.

Furthermore, during use of the earphone, some external contaminants, such as dust and sweat, may infiltrate into the sound cavity of the shell through a clearance defined between the wire and the edge of the through hole. This can adversely affect the sound quality of the earphone, and may even cause damage to the speaker.

Accordingly, what is needed is an earphone which can overcome the limitations described.

### BRIEF DESCRIPTION OF THE DRAWINGS

FIG. 1 is an isometric, assembled view of an earphone in accordance with an embodiment of the present disclosure.

FIG. 2 is an isometric, exploded view of the earphone of FIG. 1, showing another aspect thereof, but omitting a wire thereof.

FIG. 3 is a bottom view of a rear cover of a shell of the earphone of FIG. 2.

FIG. 4 is a cross-sectional view of the earphone of FIG. 1, taken along a line IV-IV thereof.

### DETAILED DESCRIPTION

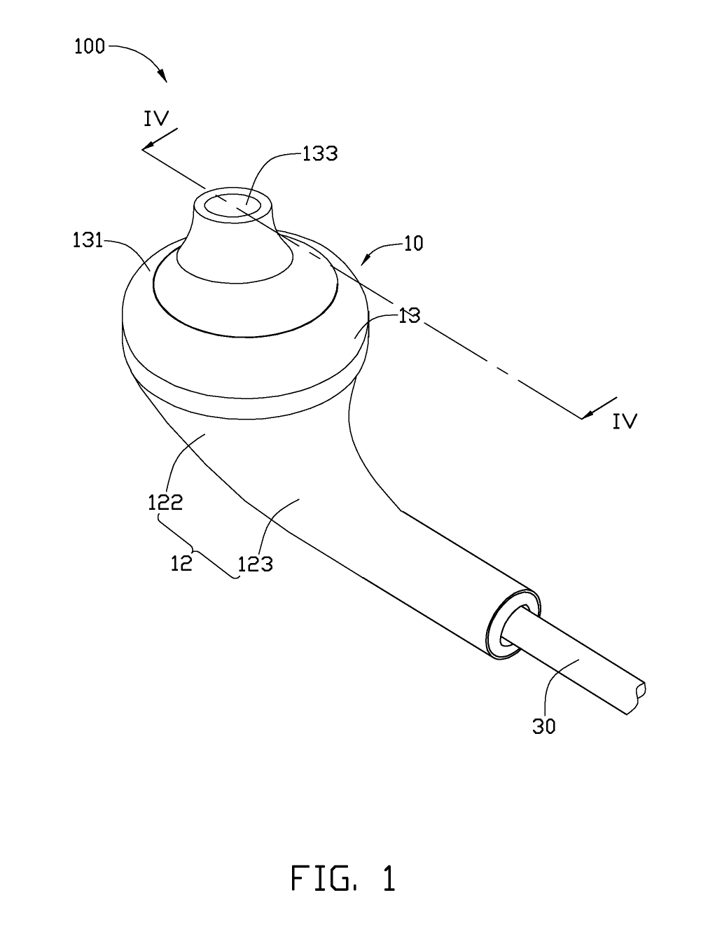

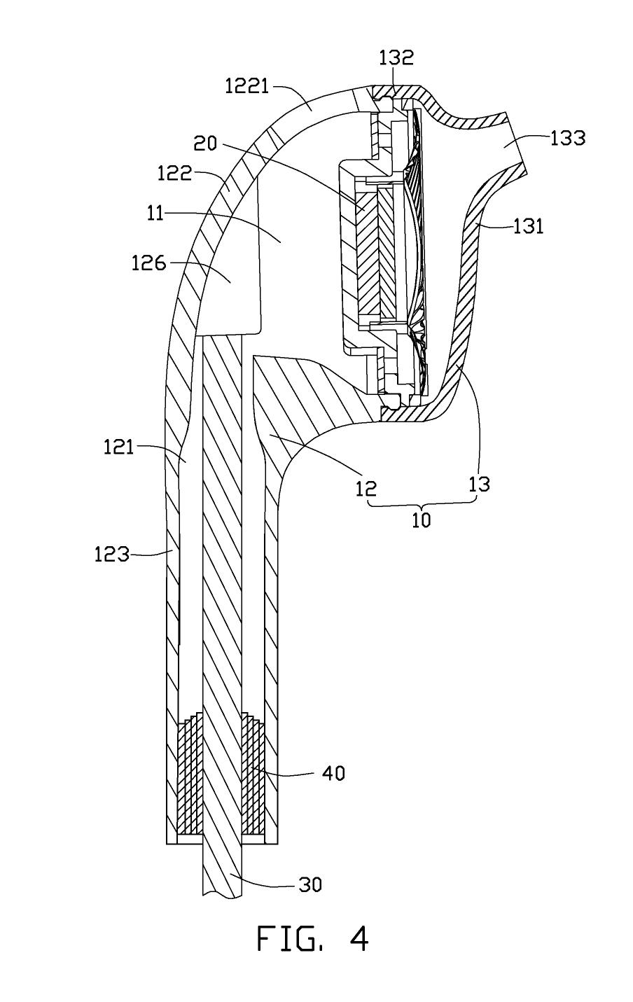

Referring to FIGS. 1 and 4, an earphone 100 according to an embodiment of the present disclosure is shown. The earphone 100 includes a shell 10, a speaker 20 mounted in the shell 10, a wire 30 electrically connected to the speaker 20, and an adhesive tape 40 wound around the wire 30. In this embodiment, the wire 30 is an electrical cable covered with an insulating sheath.

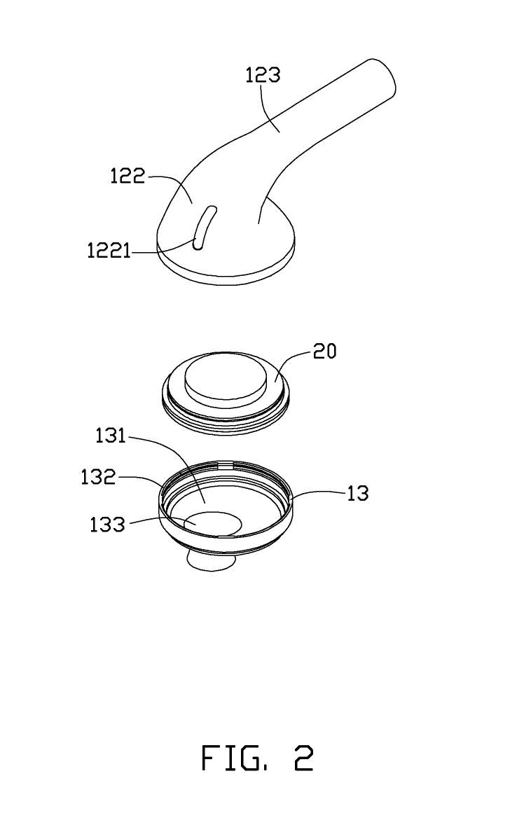

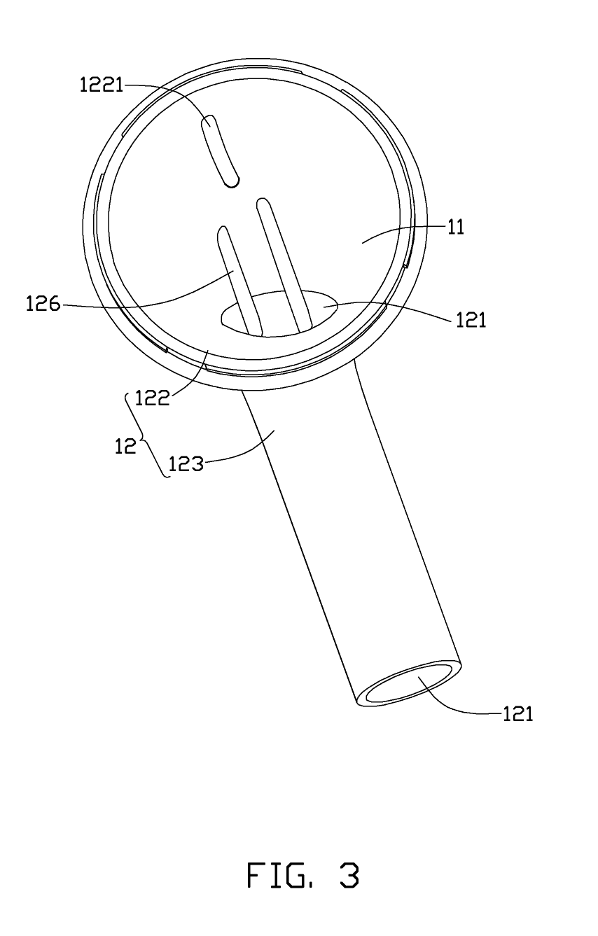

Referring also to FIGS. 2-3, the shell 10 is hollow and defines a sound cavity 11 therein. The speaker 20 is received in the sound cavity 11. The shell 10 includes a rear cover 12, and a front cover 13 engaging with the rear cover 12. The rear cover 12 and the front cover 13 cooperatively define the sound cavity 11.

The rear cover 12 defines a wire passage 121 therein. The wire passage 121 communicates with the sound cavity 11. The rear cover 12 includes a main body 122 and a tubular handle portion 123. The tubular handle portion 123 extends from one end of the main body 122, and the main body 122 expands from such end thereof towards the front cover 13. The wire passage 121 extends through the handle portion 123 longitudinally, i.e., axially.

The main body 122 defines a sound pore 1221 therein, the sound pore 1221 communicating with the sound cavity 11. The sound pore 1221 has a leaf-like shape. Two positioning plates 126 protrude from an inner face of the main body 122 adjacent to the wire passage 121. The two positioning plates 126 are parallel to each other. The wire 30 is positioned between the two positioning plates 126.

The front cover 13 is disc-shaped. The front cover 13 includes a lid 131, and a sidewall 132 extending from the lid 131 towards the rear cover 12. The lid 131 defines a sound output hole 133 facing the speaker 20, for allowing sound generated by the speaker 20 to propagate to an outside of the earphone 100. The sound pore 1221 of the rear cover 12 and the sound output hole 133 of the front cover 13 are respectively located at two opposite sides of the speaker 20, for modulating an air pressure difference between the two opposite sides of the speaker 20.

The wire 30 extends through the wire passage 121 into the sound cavity 11. The wire 30 is confined between the two positioning plates 126. The wire 30 is electrically connected to the speaker 20 to deliver sound signals to the speaker 20. The wire 30 has a diameter less than that of the wire passage 121 so that a generally annular (or cylinder-shaped) clearance (not labeled) is defined between an outer circumferential face of the wire 30 and an inner circumferential face of the handle portion 123 defining the wire passage 121.

Referring to FIG. 4, the adhesive tape 40 is a continuous piece wound around the outer circumferential face of the wire 30. The adhesive tape 40 forms a plurality of concentric coils extending from the wire 30 towards the handle portion 123 (i.e., along a radially outward direction). The adhesive tape 40 is adhesive at an inner face of each coil. Thus, an innermost coil of the adhesive tape 40 is attached to the outer circumferential face of the wire 30, and the other coils of the adhesive tape 40 are sequentially attached to each other.

The coils of the adhesive tape 40 have top ends gradually descending from the innermost coil to the outermost coil, and bottom ends terminated at the same level, as viewed in FIG. 4. That is, the coils of the adhesive tape 40 have heights gradually deceasing along the radially outward direction, as viewed in FIG. 4. The gradually descending top ends of the coils cooperatively form a tapered end of the adhesive tape 40, for facilitating insertion of the adhesive tape 40 attached on the wire 30 into the wire passage 121. A number of the coils of the adhesive tape 40 is selected to be a suitable value, to control a total radial thickness of the coils of the adhesive tape 40 to be substantially equal to a radial width of the clearance. Thus when the adhesive tape 40 together with the wire 30 is inserted in the wire passage 121, an outer circumferential face of an outmost coil of the adhesive tape 40 tightly abuts against the inner circumferential face of the handle portion 123, thereby fixing the wire 30 in the wire passage 121 by interference fit. In such position, the coils of the adhesive tape 40 are received in the wire passage 121, as viewed in FIG. 4.

During use of the earphone 100, the adhesive tape 40 prevents the wire 30 from swaying in the wire passage 121. Therefore any noise that would otherwise be generated by impacting and scraping as between the wire 30 and the inner circumferential face of the handle portion 123 is avoided. At the same time, the adhesive tape 40 seals a bottom of the wire passage 121, thereby preventing dust or sweat from entering the sound cavity 11 through the wire passage 121.

It is to be understood, however, that even though numerous characteristics and advantages of exemplary embodiments have been set forth in the foregoing description, together with details of the structures and functions of the embodiments, the disclosure is illustrative only, and that changes may be made in detail, especially in matters of shape, size, and arrangement of parts within the principles of the embodiments to the full extent indicated by the broad general meaning of the terms in which the appended claims are expressed.

What is claimed is:

1. An earphone comprising:
a shell defining a sound cavity and a wire passage therein, the sound cavity and the wire passage communicating with each other;
a speaker mounted in the sound cavity;
a wire extending through the wire passage to the sound cavity and electrically connected with the speaker; and
an adhesive tape wound around part of the wire, the adhesive tape abutting against an inner wall of the shell bounding the wire passage thereby fixing the wire in the wire passage.

2. The earphone of claim 1, wherein the adhesive tape comprises a plurality of coils wound around the part of the wire in radial sequence.

3. The earphone of claim 2, wherein the coils of the adhesive tape have top ends gradually descending along a radially outward direction of the adhesive tape such that a top end of the adhesive tape is tapered.

4. The earphone of claim 3, wherein the coils of the adhesive tape have bottom ends level with each other along the radially outward direction of the adhesive tape.

5. The earphone of claim 2, wherein the coils of the adhesive tape are wholly received in the wire passage.

6. The earphone of claim 1, wherein the shell comprises a front cover and a rear cover connected to the front cover, the sound cavity being defined between the front cover and the rear cover.

7. The earphone of claim 6, wherein the rear cover comprises a main body and a handle portion extending from the main body, the wire passage being defined in the handle portion.

8. The earphone of claim 7, wherein the main body gradually expands from an end thereof adjacent to the handle portion towards the front cover.

9. The earphone of claim 7, wherein the rear cover comprises two parallel plates formed on an inner wall of the main body adjacent to the wire passage, the wire being positioned between the two parallel plates.

10. The earphone of claim 7, wherein the rear cover comprises a sound pore defined in the main body.

11. The earphone of claim 10, wherein the front cover defines a sound output hole communicating with the sound cavity.

12. The earphone of claim 11, wherein the speaker is located between the sound pore and the sound output hole.
